(19) United States
(12) Patent Application Publication
(10) Pub. No.: US 2026/0113271 A1
(43) Pub. Date: Apr. 23, 2026

(54) MESSAGING SERVICES GATEWAY WITH SECURE ACCESS SERVICE EDGE

(71) Applicant: T-MOBILE INNOVATIONS LLC, Overland Park, KS (US)

(72) Inventors: Anis Adil Anis, Bay Point, CA (US); Sagar Satish Vanjari, Aldie, VA (US); Tamas Felker, Woodinville, WA (US); Cristian Asandului, Snoqualmie, WA (US)

(21) Appl. No.: 18/924,309

(22) Filed: Oct. 23, 2024

(51) Int. Cl. H04L 45/74; H04L 9/40

(52) U.S. Cl. CPC H04L 45/74; H04L 63/02; H04L 63/20

(57) ABSTRACT

The technology disclosed herein relates to systems, methods, and computer storage media for providing messaging services with secure access service edge (SASE). In aspects, a SASE gateway service directly processes all traffic and manages routing of various types of traffic. For example, external traffic is routed to the internet. In contrast, internal traffic is routed through an additional transport leg back to the mobile network operator (MNO). The internal traffic may be for internal services provided by the MNO, such as short message service (SMS) or multimedia messaging service (MMS).

### SUMMARY

In aspects set forth herein, and at a high level, the technology described herein relates to systems, methods, and computer storage media for providing messaging services with secure access service edge (SASE). In aspects, a messaging services gateway directly processes all traffic and manages routing of various types of traffic. For example, external traffic is routed to the internet. In contrast, internal traffic is routed through an additional transport leg back to the mobile network operator (MNO). The internal traffic may be for internal services provided by the MNO, such as short message service (SMS) or multimedia messaging service (MMS).

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present technology are described in detail herein with reference to the attached figures, which are intended to be exemplary and non-limiting, wherein:

FIG. 1 illustrates a diagram of an exemplary communication environment in which implementations of the present disclosure may be employed;

FIG. 2 illustrates a diagram of an example of communication network for providing a messaging services gateway, in accordance with aspects herein;

FIG. 3A is diagram of an example multimedia messaging service flow using a messaging services gateway, in accordance with aspects herein;

FIG. 3B is a diagram of an example internet flow using a messaging services gateway, in accordance with aspects herein;

FIG. 4 is a flow diagram of an example method for providing a messaging services gateway, in accordance with some aspects of the technology described herein; and

FIG. 5 depicts an example computing environment suitable for use in implementation of the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
6G Sixth-Generation Cellular Communication System
AI Artificial Intelligence
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
ML Machine Learning
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Signal Receive Power
RSRQ Reference Signal Receive Quality
RSSI Received Signal Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. An illustrative resource that fleshes out various aspects of these terms can be found in Newton's Telecom Dictionary, 32^{nd} Edition (2022).

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an eNodeB). In this regard, typically only one active uplink connection can occur per frequency. The base station may include one or more sectors served by individual transmitting/receiving components associated with the base station (e.g., antenna arrays controlled by an eNodeB). These transmitting/receiving components together form a multi-sector broadcast arc for communication with mobile handsets linked to the base station.

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE), wherein the base station is not intended to be used while in motion in the provision of the service.

The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network.

For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point. A UE may be, in an embodiment, similar to device 600 described herein with respect to FIG. 6.

By way of background, wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Edge based security services provide security controls at a point of access instead of routing traffic to a data center where security policies are enforced. Points of access may include a user device, an Internet-of-Things (IoT) device, an access network, an edge computing location, and the like. Secure Access Service Edge (SASE) is a type of edge-based security service. SASE ensures real-time, context aware policy enforcement to secure user and device traffic. SASE comprises a flexible zero trust architecture that enforces security policies on data sessions between user devices and enterprise networks and/or the public internet. SASE encompasses a range of security solutions, including Zero Trust Network Access (ZTNA), Secure Web Gateways (SWG), Cloud Access Security Brokers (CASB), Firewall as a Service (FWaaS), and the like. This integrated approach allows SASE to provide secure and optimized connectivity to cloud services, applications, and resources from any location or device. SASE routes traffic to user devices based on the device's Internet Protocol (IP) address.

In conventional SASE systems, the SASE gateway initially receives traffic from the MNO. Security features are applied and all traffic is routed back to the MNO. The MNO then routes the internal traffic corresponding to internal services (e.g., SMS or MMS) provided by the MNO to servers of the MNO and external traffic to the internet. Because the MNO is routing all traffic through the same transport leg, external traffic may suffer from latency at the network core. Moreover, the external traffic is restricted to a single location for point-to-point, direct connectivity, resulting in additional latency.

The present disclosure is directed to systems, methods, and computer readable media that systems and methods for providing messaging services with SASE. In aspects, a messaging services gateway directly processes all traffic and manages routing of various types of traffic. For example, external traffic is routed to the internet. In contrast, internal traffic is routed through an additional transport leg back to the MNO. The internal traffic may be for internal services provided by the MNO, such as SMS or MMS. As a result, private servers of the MNO are not exposed to the internet, which improves security for the MNO. Moreover, latency is reduced because the internal traffic is segregated from the external traffic (i.e., internet traffic). Additionally, flexibility to utilize cloud providers to route external traffic is realized because the cloud is mesh connected and latency is reduced further.

In aspects, internet traffic is initially routed from an interface of the core network to the SASE virtual routing and forwarding (VRF) of the MNO. The internet traffic traverses the SASE VRF and is routed to the SASE infrastructure. At the SASE gateway, Network Address Translation (NAT) translates the private IP addresses to a public IP address and sends packets to the internet.

In other aspects, internal traffic (e.g., SMS or MMS traffic) is also initially routed from the interface of the core network to the SASE VRF of the MNO. The internet traffic traverses the SASE VRF and is routed to the SASE infrastructure. At the SASE gateway, since the internal traffic can be uniquely identified with a private IP address in a designated private IP, a messaging services gateway (which may be integrated with the SASE gateway) interfaces with a different sub-interface of the core network and routes the internal traffic back through the sub-interface of the core network to a server of the MNO corresponding to the appropriate service (e.g., SMS or MMS). In this regard, the internal traffic is segregated from the internet traffic and the server of the MNO is not exposed to the internet.

Accordingly, in a first aspect of the present invention, computer-readable media is provided, the computer-readable media having computer-executable instructions embodied thereon that, when executed, perform a method of providing a messaging services gateway with secure access service edge (SASE). The method comprises forwarding packets, received at a first virtual routing and forwarding (VRF) service of a core network from a user device (UE), to a messaging services gateway. The method also comprises determining, at the messaging services gateway, a destination internet protocol (IP) address of the packets. The method further comprises based on the determining, routing the packets to a private server via a second VRF service of the core network or to a data network.

A second aspect of the present disclosure is directed to a method of providing a messaging services gateway with secure access service edge (SASE). The method comprises forwarding packets, received at a first virtual routing and forwarding (VRF) service of a core network from a user device (UE), to a messaging services gateway. The method also comprises determining, at the messaging services gateway, a destination internet protocol (IP) address of the packets. The method further comprises based on the determining, routing the packets to a private server via a second VRF service of the core network or to a data network.

Another aspect of the present disclosure is directed to a system for providing a messaging services gateway with secure access service edge (SASE). The system comprises: a node configured to wirelessly communicate with user equipment (UE) via a messaging services gateway; and the messaging services gateway configured to: forward packets, received at a first virtual routing and forwarding (VRF) service of a core network from a user device (UE), to a messaging services gateway; determine, at the messaging services gateway, a destination internet protocol (IP) address of the packets; and based on the determining, route the packets to a private server via a second VRF service of the core network or to a data network.

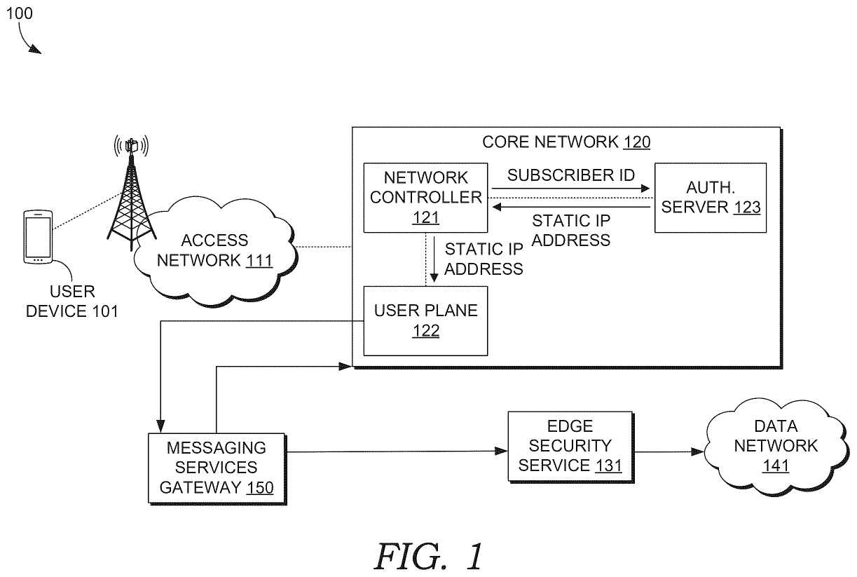

FIG. 1 illustrates a diagram of an exemplary communication environment 100 in which implementations of the present disclosure may be employed. Communication network 100 provides services like media-streaming, internet-access, voice/video calling, text messaging, machine communications, or some other wireless communications product. Communication network 100 comprises user device 101, access network 111, core network 120, edge security service 131, data network 141, and messaging services gateway 150. Core network 120 comprises network controller 121, user plane 122, and authentication server 123. In other examples, communication network 100 may comprise additional or different elements than those illustrated in FIG. 1.

Various examples of network operation and configuration are described herein. In some examples, user device 101 attaches to core network 120 over access network 111. Device 101 transfers a registration request to network controller 121 over access network 111 to register for service on communication network 100. The registration request includes a subscriber Identifier (ID). Exemplary subscriber IDs include Subscriber Concealed Identifier (SUCI), Subscriber Permanent Identifier (SUPI), International Mobile Subscriber Identifier (IMSI), Fifth Generation Global Unique Temporary Identifier (5G-GUTI), and the like. Network controller 121 receives the registration request and authenticates the subscriber ID indicated by device 101. Additionally, the registration request comprises a request for a static IP address. Responsive to authentication, network controller 121 authorizes device 101 for service on network 100 and detects if user device is subscribed for static IP address assignment and edge-based security service. In response, network controller 121 forwards the subscriber ID to authentication server 123. Authentication server 123 performs a secondary authentication of user device 101. Authentication server 123 maps the subscriber ID for device 101 to the static IP segment and indicates the static IP address to network controller 121. Static IP assignments are IP addresses that are reserved for a specific device and do not change. This contrasts with dynamic IP addresses, which are assigned to devices on a temporary basis and can change over time. Static IP assignments can be useful for a variety of purposes, including remote device management, hosting servers, and running certain applications. Network controller 121 assigns the static IP address to device 101 to use for data sessions on network 100.

Network controller 121 indicates the static IP address to device 101 and to user plane 122. User plane 122 forwards the IP address and subscriber ID for device 101 to messaging services gateway 150 (which may be provided by edge-based service 131 (e.g., SASE vendor)). In aspects, the messaging services gateway 150 determines if the traffic is internal traffic or external traffic and routes the traffic appropriately (e.g., internal traffic is routed through an additional transport leg back to the MNO and external traffic is routed to the SASE infrastructure and out to the internet). Importantly, only the internal traffic is routed back to the core network 120. User device begins a data session on network 100. User device 101 exchanges user data for the session with user plane 122 over access network 111. The messaging services gateway 150 determines (based on the destination IP address) if the traffic is internal traffic or external traffic. If the traffic is internal, messaging services gateway 150 routes the traffic to edge security service 131 (which may provide messaging services gateway 150) where content filtering, session security, malware scanning, contents filtering, Domain Name System (DNS) filtering, firewall, intrusion detection and the like may be performed. Edge security service 131 routes the internal traffic back to the core network 120.

In contrast, if the traffic is external traffic, messaging services gateway 150 routes the traffic to edge security service 131 where content filtering, session security, malware scanning, contents filtering, Domain Name System (DNS) filtering, firewall, intrusion detection and the like may be performed. Edge security service 131 routes the external traffic to the data network 141 (e.g., internet or enterprise network) based on the static IP address.

Advantageously, wireless communication network 100 effectively and efficiently routes traffic from user devices to facilitate communication between the user devices and the appropriate destination. Moreover, by segregating internal and external traffic (i.e., routing internal traffic through an additional transport leg to the MNO and routing external traffic to the internet or enterprise network), resources (e.g., CPU, bandwidth, physical infrastructure) required by the core network 120 to route traffic are significantly reduced.

User device 101 comprises a vehicle, drone, robot, computer, phone, sensor, or another type of data appliance with wireless and/or wireline communication circuitry. User device 101 and access network 111 communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WIFI), Low-Power Wide Area Network (LP-WAN), Bluetooth, and/or some other type of wireless networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Although access network 111 is illustrated as a tower, network 111 may comprise another type of mounting structure (e.g., a building), or no mounting structure at all. Access network 111 comprises a Sixth Generation (6G) Radio Access Network (RAN), Fifth Generation (5G) RAN, LTE RAN, gNodeB, eNodeB, NB-IoT access node, trusted non-3GPP access node, untrusted non-3GPP access node, LP-WAN base station, wireless relay, WIFI hotspot, Bluetooth access node, and/or another wireless or wireline network transceiver. Access network 111 exchanges network signaling and user data with network controller 121 and user plane 122 clustered together into core network 120. Access network 111 is connected to network core 120 over backhaul data links. Access network 111 and core network 120 may communicate via edge networks like internet backbone providers, edge computing systems, or another type of edge system to provide the backhaul data links between node 111 and core network 120.

Access network 111 may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 120. Access network 111 may comprise Baseband Units (BBUs). The BBUs handle lower and higher network layers like RRC, PDCP, RLC, MAC, and PHY. The BBUs are coupled to network entities in core 120.

Core network 120 is representative of computing systems that provide wireless data services to user device 101 over access network 111. Exemplary computing systems comprise Network Function Virtualization Infrastructure (NFVI) systems, data centers, server farms, cloud computing networks, hybrid cloud networks, and the like. Core network 120 may comprise a Third Generation Partnership Project (3GPP) core network architecture like Sixth Generation Core (6GC), Fifth Generation Core (5GC), Evolved Packet Core (EPC), and/or another type of 3GPP core network architecture. Access network 111, core network 120, edge security service 131, data network 141, and Message services gateway 150 communicate over various links that use metallic links, glass fibers, radio channels, or some other communication media. The links use 6GC, 5GC, EPC, IEEE 802.3 (ENET), Time Division Multiplex (TDM), Data Over Cable System Interface Specification (DOCSIS), Internet Protocol (IP), General Packet Radio Service Transfer Protocol (GTP), 6GR, 5GNR, LTE, WIFI, virtual switching, inter-processor communication, bus interfaces, and/or some other data communication protocols. The computing systems of core network 120 store and execute the network functions/entities to form network controller 121, user plane 122, and authentication server 123. Network controller 121 may comprise network functions/entities like Access and Mobility Management Function (AMF), Session Management Function (SMF), Authentication Server Function (AUSF), Unified Data Management (UDM), Mobility Management Entity (MME), and Home Subscriber Server (HSS). User plane 122 comprises network functions/entities like User Plane Function (UPF), Serving Gateway (S-GW), Packet Gateway (P-GW). Authentication server 123 comprises network functions/entities like Authentication, Authorization, and Accounting (AAA) server and the like.

Edge security service 131 comprises a cloud-based computing system that applies security policies on sessions between core network 120 and data network 141. Edge security service 131 may comprise a Secure Access Service Edge (SASE). In other examples, edge security service 131 may provide another type of edge-based service (e.g., content distribution). In some aspects, messaging services gateway 150 is incorporated into or provided by edge security service 131. In aspects, data network 141 is the internet or enterprise network.

User device 101 and access network 111 comprise antennas, amplifiers, filters, modulation, analog/digital interfaces, microprocessors, software, memories, transceivers, bus circuitry, and the like. User device 101, access network 111, core network 120, edge security service 131, data network 141, and messaging services gateway 150 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, disk drives, and/or the like. The memories store software like operating systems, user applications, radio applications, and network functions. The microprocessors retrieve the software from the memories and execute the software to drive the operation of wireless communication network 100 as described herein.

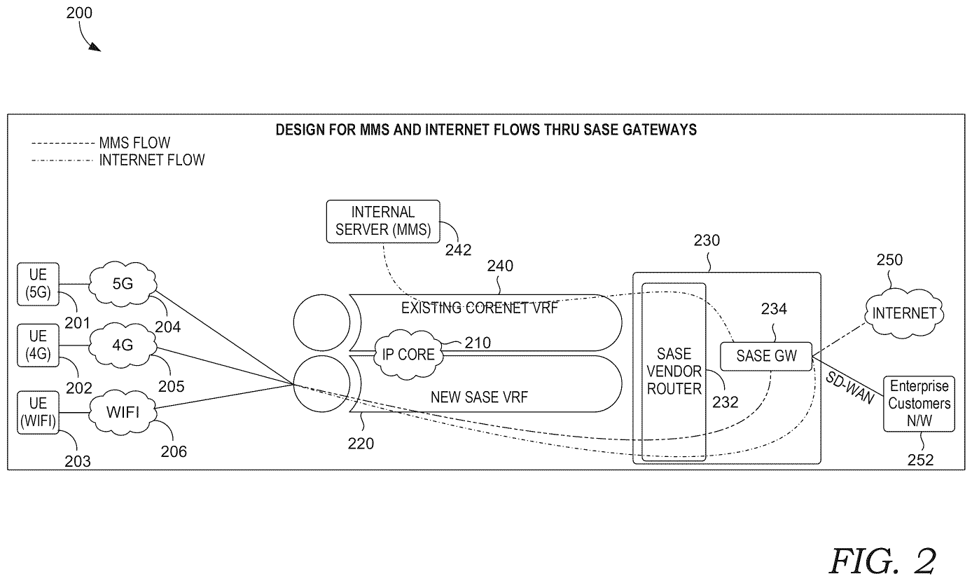

Referring now to FIG. 2, a diagram of an example of communication network 200 for providing a messaging services gateway is illustrated, in accordance with aspects herein. As shown, devices 201, 202, 203 initially attach to the appropriate network 204, 205, 206 provided by the IP core 210 for a particular MNO. All traffic, both internal and external, is initially routed through the SASE VRF 220 and onto the SASE complex 230. The SASE vendor route 232 passes the traffic to the SASE gateway 234 (i.e., a messaging services gateway). The SASE gateway 234 inspects the packets and determines whether the traffic is internal or external based on the destination IP address of the packets.

In aspects, if the destination IP address indicates the traffic is internal, the SASE gateway 234 applies security policies and translates the private IP address to a public IP address. The SASE gateway 234 routes the packets back to internal servers 242 in a separate VRF domain (i.e., the corenet VRF 240).

In aspects, if the destination IP address indicates the traffic is external, the SASE gateway 234 applies security policies and translates the private IP address to a public IP address. The SASE gateway 234 routes the packets to the internet 250 or to an enterprise network 252.

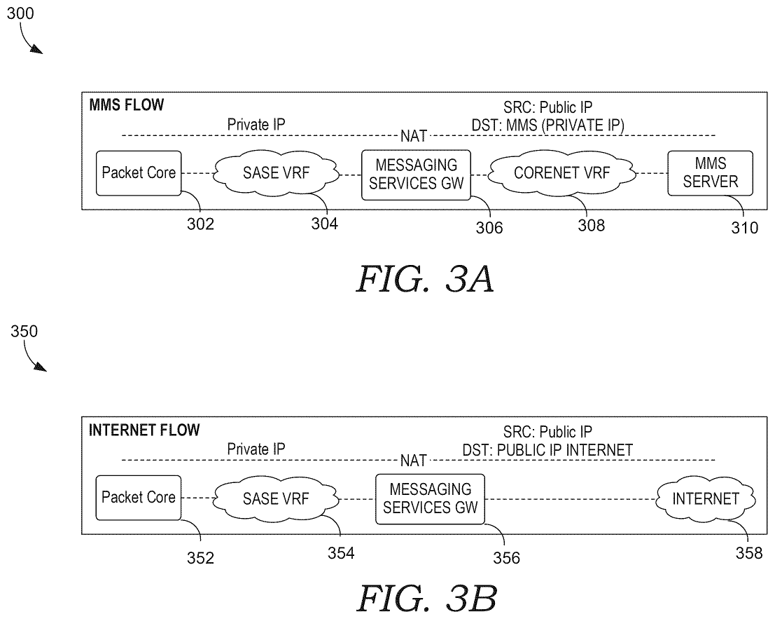

In FIG. 3A, a diagram of an example multimedia messaging service flow 300 using a messaging services gateway is illustrated, in accordance with aspects herein. As illustrated, the internal traffic originates at the packet core 302 and traverses the SASE VRF 304. The SASE VRF 304 is private and contains prefixes that are not leaked into the public routing domains. The SASE VRF 304 hands over the internal traffic to the messaging services gateway 306 (which may be integrated into the SASE complex). The messaging services gateway 306 applies security policies and translates the private IP address to a public IP address. The messaging services gateway 306 routes the packets back to internal servers 310 in a separate VRF domain (i.e., the corenet VRF 308).

In FIG. 3B, a diagram of an example internet flow 350 using a messaging services gateway, in accordance with aspects herein. As illustrated, the internet traffic originates at the packet core 352, traverses the SASE VRF 354 and is handed over to the messaging services gateway 356 (which may be integrated into the SASE complex). The messaging services gateway 356 translates the private IP address to a public IP address and forwards the packets to the internet 358.

Importantly, all SASE related packet core traffic is forwarded to the messaging services gateway through a dedicated SASE VRF. The messaging services gateway validates the flow and inspects the packets to identify the destination IP address. As described, if the destination IP address is internal (e.g., MMS, SMS, location services, etc.), the messaging services gateway translates the private IP address to a public IP address and routes the traffic back to the MNO via the corenet VRF. The corenet VRF has access to the internal servers corresponding to the internal services (e.g., MMS, SMS, location services, etc.), thus providing a secure flow for internal services. If the destination IP address is external, the messaging services gateway translates the private IP address to a public IP address and routes the traffic to the internet.

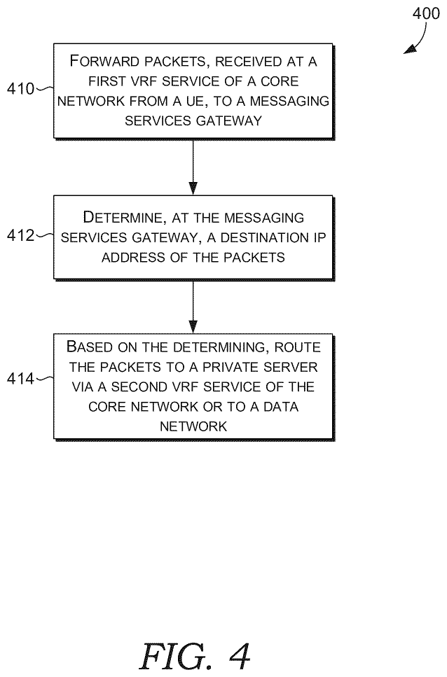

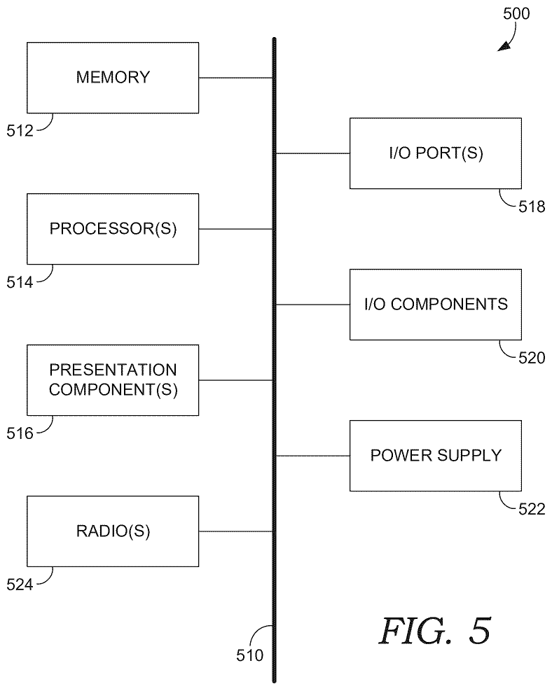

Referring now to FIG. 4, an example flowchart depicts a method of providing a messaging services gateway with secure access service edge (SASE), in accordance with aspects of the present invention. Method 400 may be performed by any computing device (such as computing device described with respect to FIG. 5 or components of communication network (such as the communication network described with respect to FIG. 1 or 2). Initially, at step 410, packets, received at a first virtual routing and forwarding (VRF) service of a core network from a user device (UE), are forwarded to a messaging services gateway. In some aspects, the messaging services gateway is provided by a SASE vendor.

At step 412, a destination internet protocol (IP) address of the packets is determined at the messaging services gateway. In some aspects, based on the destination IP address, the packets are determined to be internal traffic requesting services provided by internal servers of a mobile network operator (MNO) corresponding to the core network. The messaging services gateway may apply security policies to the packets. Additionally, the messaging services gateway may translate a private IP address corresponding to the packets to a public IP address.

At step 414, based on the determining, the packets are routed to a private server of the internal servers via a second VRF service of the core network or to a data network. In some aspects, the private server provides services such as multimedia messaging service (MMS) or short message service (SMS). In some aspects, the data network is an enterprise network or the Internet.

Having described the example embodiments discussed above of the presently disclosed technology, an example operating environment of an example user device is described below with respect to FIG. 5. User device 500 is but one example of a suitable computing environment, and is not intended to suggest any particular limitation as to the scope of use or functionality of the technology disclosed. Neither should user device 500 be interpreted as having any dependency or requirement relating to any particular component illustrated, or a particular combination of the components illustrated in FIG. 5.

As illustrated in FIG. 5, example user device 500 includes a bus 502 that directly or indirectly couples the following devices: memory 504, one or more processors 506, one or more presentation components 508, one or more input/output (I/O) ports 510, one or more I/O components 512, a power supply 522, and one or more radios 524.

Example user device 500 may be configured to wirelessly communicate (e.g., by transmitting or receiving one or more signals) with one or more of the antenna elements of FIG. 1 or FIG. 1, other types of wireless telecommunication devices (e.g., other user devices, network nodes), or one or more combinations thereof. In embodiments, the user device 500 may include one or more of a unit, a station, a terminal, or a client, for example. In some embodiments, the user device 500 may act as a relay. In some embodiments, the user device 500 may be a wireless local loop station, an IoT device, an Internet of Everything device, a machine type communication device, an evolved or enhanced machine type communication device, another type of user device, or one or more combinations thereof.

Bus 502 represents what may be one or more busses (such as an address bus, data bus, or combination thereof). Although the various blocks of FIG. 5 are shown with lines for the sake of clarity, in reality, these blocks represent logical, not necessarily actual, components. For example, one may consider a presentation component, such as a display device, to be an I/O component. Also, processors have memory. Accordingly, FIG. 5 is merely illustrative of an exemplary user device that can be used in connection with one or more embodiments of the technology disclosed herein.

User device 500 can include a variety of computer-readable media. Computer-readable media can be any available media that can be accessed by user device 500 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 500. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 504 includes computer storage media in the form of volatile and/or nonvolatile memory. The memory 504 may be removable, non-removable, or a combination thereof. Example hardware devices of memory 504 may include solid-state memory, hard drives, optical-disc drives, other hardware, or one or more combinations thereof. As indicated above, the computer storage media of the memory 504 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 500, or one or more combinations thereof.

The one or more processors 506 of user device 500 can read data from various entities, such as the memory 504 or the I/O component(s) 512. The one or more processors 506 may include, for example, one or more microprocessors, one or more CPUs, a digital signal processor, one or more cores, a host processor, a controller, a chip, a microchip, one or more circuits, a logic unit, an integrated circuit (IC), an application-specific IC (ASIC), any other suitable multi-purpose or specific processor or controller, or one or more combinations thereof. In addition, the one or more processors 506 can execute instructions, for example, of an operating system of the user device 500 or of one or more suitable applications.

The one or more presentation components 508 can present data indications via user device 500, another user device, or a combination thereof. Example presentation components 508 may include a display device, speaker, printing component, vibrating component, another type of presentation component, or one or more combinations thereof. In some embodiments, the one or more presentation components 508 may comprise one or more applications or services on a user device, across a plurality of user devices, or in the cloud. The one or more presentation components 508 can generate user interface features, such as graphics, buttons, sliders, menus, lists, prompts, charts, audio prompts, alerts, vibrations, pop-ups, notification-bar or status-bar items, in-app notifications, other user interface features, or one or more combinations thereof.

The one or more I/O ports 510 allow user device 500 to be logically coupled to other devices, including the one or more I/O components 512, some of which may be built in. Example I/O components 512 can include a microphone, joystick, game pad, satellite dish, scanner, printer, wireless device, and the like. The one or more I/O components 512 may, for example, provide a natural user interface (NUI) that processes air gestures, voice, or other physiological inputs generated by a user. In some instances, the inputs the user generates may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with the one or more presentation components 508 on the user device 500. In some embodiments, the user device 500 may be equipped with one or more imaging devices, such as one or more depth cameras, one or more stereoscopic cameras, one or more infrared cameras, one or more RGB cameras, another type of imaging device, or one or more combinations thereof, (e.g., for gesture detection and recognition). Additionally, the user device 500 may, additionally or alternatively, be equipped with accelerometers or gyroscopes that enable detection of motion. In some embodiments, the output of the accelerometers or gyroscopes may be provided to the one or more presentation components 508 of the user device 500 to render immersive augmented reality or virtual reality.

The power supply 522 of user device 500 may be implemented as one or more batteries or another power source for providing power to components of the user device 500. In embodiments, the power supply 522 can include an external power supply, such as an AC adapter or a powered docking cradle that supplements or recharges the one or more batteries. In aspects, the external power supply can override one or more batteries or another type of power source located within the user device 500.

Some embodiments of user device 500 may include one or more radios 524 (or similar wireless communication components). The one or more radios 524 can transmit, receive, or both transmit and receive signals for wireless communications. In embodiments, the user device 500 may be a wireless terminal adapted to receive communications and media over various wireless networks. User device 500 may communicate using the one or more radios 524 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 802.16 protocols), or one or more combinations thereof. In some embodiments, the one or more radios 524 may facilitate communication via radio frequency signals, frames, blocks, transmission streams, packets, messages, data items, data, another type of wireless communication, or one or more combinations thereof. The one or more radios 524 may be capable of transmitting, receiving, or both transmitting and receiving wireless communications via mm waves, FD-MIMO, massive MIMO, 3G, 4G, 5G, 6G, another type of Generation, 802.11 protocols and techniques, another type of wireless communication, or one or more combinations thereof.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. One or more computer-readable media having computer-executable instructions embodied thereon that, when executed, perform a method of providing a messaging services gateway with secure access service edge (SASE), the method comprising:
forwarding packets, received at a first virtual routing and forwarding (VRF) service of a core network from a user device (UE), to a messaging services gateway;
determining, at the messaging services gateway, a destination internet protocol (IP) address of the packets;
based on the determining, routing the packets to a private server via a second VRF service of the core network or to a data network.

2. The media of claim 1, wherein the messaging services gateway is provided by a SASE vendor.

3. The media of claim 1, wherein the data network is an enterprise network or the Internet.

4. The media of claim 1, further comprising determining, based on the destination IP address, the packets are internal traffic requesting services provided by internal servers of a mobile network operator (MNO) corresponding to the core network.

5. The media of claim 4, wherein the services are multimedia messaging service (MMS) or short message service (SMS).

6. The media of claim 1, further comprising applying security policies to the packets.

7. The media of claim 1, further comprising translating a private IP address corresponding to the packets to a public IP address.

8. A method for providing a messaging services gateway with secure access service edge (SASE), the method comprising:
forwarding packets, received at a first virtual routing and forwarding (VRF) service of a core network from a user device (UE), to a messaging services gateway;
determining, at the messaging services gateway, a destination internet protocol (IP) address of the packets; and
based on the determining, routing the packets to a private server via a second VRF service of the core network or to a data network.

9. The method of claim 8, wherein the messaging services gateway is provided by a SASE vendor.

10. The method of claim 8, wherein the data network is an enterprise network or the Internet.

11. The method of claim 8, further comprising determining, based on the destination IP address, the packets are internal traffic requesting services provided by internal servers of a mobile network operator (MNO) corresponding to the core network.

12. The method of claim 11, wherein the services are multimedia messaging service (MMS) or short message service (SMS).

13. The method of claim 8, further comprising applying security policies to the packets.

14. The method of claim 8, further comprising translating a private IP address corresponding to the packets to a public IP address.

15. A system for providing a messaging services gateway with secure access service edge (SASE), the system comprising:
a node configured to wirelessly communicate with user equipment (UE) via a messaging services gateway; and
the messaging services gateway configured to:
forward packets, received at a first virtual routing and forwarding (VRF) service of a core network from a user device (UE), to a messaging services gateway;
determine, at the messaging services gateway, a destination internet protocol (IP) address of the packets; and
based on the determining, route the packets to a private server via a second VRF service of the core network or to a data network.

16. The system of claim 15, further comprising determining, based on the destination IP address, the packets are internal traffic requesting services provided by internal servers of a mobile network operator (MNO) corresponding to the core network.

17. The system of claim 16, wherein the services are multimedia messaging service (MMS) or short message service (SMS).

18. The system of claim 15, further comprising applying security policies to the packets.

19. The system of claim 15, further comprising translating a private IP address corresponding to the packets to a public IP address.

20. The system of claim 15, wherein the messaging services gateway is provided by a SASE vendor.
